(19) United States
(12) Patent Application Publication
(10) Pub. No.: US 2005/0202876 A1
(43) Pub. Date: Sep. 15, 2005

(54) Multipurpose amusement machine

(76) Inventor: Jesus Franco Munoz, Madrid (ES)

Correspondence Address: BLANK ROME LLP, 600 NEW HAMPSHIRE AVENUE, N.W., WASHINGTON, DC, 20037, US

(21) Appl. No.: 11/008,218

(22) Filed: Dec. 10, 2004

(30) Foreign Application Priority Data
Mar. 12, 2004 (ES) P200400615

(51) Int. Cl. A63F 13/00

(52) U.S. Cl. 463/42; 463/20

(57) ABSTRACT

Based on a CPU main plate (1), where the base program controlling the entire operating system, statistical data base, accounting and processing, as well as game rules, implemented, and a series of secondary plates such as the push button box (2), winnings plan (3), displays (4), upper lights (5), coin meter (6), rollers (7), coin and bill selector (8), hopper (9), electromechanical meters (10) and printer (12) with access from the exterior, which receive commands from the CPU (1) and which send information thereto, the secondary plates (2) to (10) are independent from the main plate in their order and opportunity of actuation, and independent each one of them in the configuration and level of the commands which they send to the mechanisms they control, such that the main plate (1) is unique and non-detachable, inasmuch as the secondary plates (2) to (10) can undergo modifications in both codification and number, according to the mechanisms to which they have to provide service, all the plates, main plate (1) and secondary plates (2) to (10), being connected by a bus (11) carried out in two conductor cables through which all the information generated and acquired by each plate is sent.

### OBJECT OF THE INVENTION

The present invention refers to an amusement machine, of the type commonly known as a slot machine, i.e. of the type which will grant the user a use or playing time in exchange for the price of one game and possibly, according to the game program, a cash prize.

The object of the invention is focused on a machine allowing for the replacement of mechanisms thereof without needing to modify the CPU base program, specifically the replacement of assemblies, subassemblies or auxiliary parts of mechanisms functioning by means of commands contained in the software, the elimination of a considerable number of cables and connection points inside the machine being achieved in parallel by reducing the conductors and contact points between plates to two.

More specifically, the object of the invention is to be able to replace any of the electronic or electromechanical mechanisms contained in the machine with other similar mechanisms but of different technical features, and therefore with different configuration parameters, without this affecting the communications or commands established between the CPU unit and the mechanisms which must execute its commands, while at the same time establishing a closed loop for the communication protocol between the CPU central unit and the peripheral plates, a loop exclusively consisting of the two mentioned conductor cables.

### BACKGROUND OF THE INVENTION

This type of machines is known in the state of the art, in which, after the insertion of the amount for the game, the player is required to operate a mechanism for starting the game; a game usually characterized by the controlled rotation of a cluster (usually three or four) of reels, rollers or any other type of similar mechanism, bearing symbols or figures on their peripheral bands and which, situated in a row and visible to the player, will form in their alignment a combination of symbols or figures once they have stopped, which will be the result of the play.

Said combination could be a winning or losing combination, according to the values specified in a predetermined table known as the Winnings Plan, whereby if the resulting combination is one of the winning combinations, the machine then either pays the amount of said winnings or else retains it in a “deposit” accounted for in the machine for its subsequent collection or conversion into fractioned credits, according to the player's wishes.

In their most basic version, these machines can be formed by an undetermined number or rollers; reels; belts; display windows; or else a video display with the virtual representation of any type of mechanism of those previously mentioned, mechanical or electronic, capable of providing an exchange of images which can be visualized by a player in the front of a machine, although generally there are usually three basic rollers intervening in the games to be developed.

Subsequently, and as the player became more accustomed to the form of the game of the machines, it was necessary to add new game options with more novel and appealing mechanisms in order to fully respond to the demands of the players, introducing as a complement to the roller games elements such as:

Other additional or complementary roller games; roulettes; drums with dice; labyrinths, etc.

And in the same manner, and while at the same time allowed for by the art, auxiliary elements were coupled for the more accurate control and operation of the machine, such as:

Coin selectors which accepted a wider variety of coins.

Coin sorters with connection paths inside the machine for leading each coin that was accepted to a determined place.

Additional hoppers for carrying out the payment of coins of different value.

Bill selectors for accepting the payment of plays with paper money.

Electromechanical meters-numbering apparatuses for each different type of coin accepted.

Each one of the mechanisms described above is provided with motors or electromagnets of the most diverse types and models according to the cases, and in the same manner and for their control, with the corresponding “optoswitches”.

And as a complement, a considerable number of light points for the purpose of guiding the information to the player.

The electronic operation of the machines is based on a CPU plate. The microprocessor and memory assembly with the corresponding game program are contained in said plate; therefore, the actuating signals of the different mechanical/electrical or electronic elements, which are activated during the development of the plays, reach said plate at all times.

Said signals, commonly called inputs or outputs, in each case come from a determined mechanism, and each one of them is transmitted through an independent conductor cable; they are commands to be processed in the memory according to the pre-established program.

Each one of the previously mentioned input signals has been configured for response time, order and capacity in accordance with the mechanism that has generated them, such that if the mechanism changes features, in a similar manner the signal identifying it would have to change values.

As consideration and response to the previously mentioned input signals, the CPU generates commands, according to the established program, called output signals, which are sent through independent conductor cables for each one of the light points or electromechanical mechanisms which must be fed in the operation of a machine.

Each one of the previously mentioned output signals has been configured for response time, order and capacity in accordance with the mechanism which it must serve, such that if the mechanism changes features, the signal “feeding” it will also have to change values.

As a result of all this, there is a conductor cable for each input signal between the mechanisms generating the commands for the execution of the game of a machine and the CPU processing unit, and a conductor cable for each output signal between the CPU processing unit and the different mechanisms and lights executing the commands for the attainment of said games, as well as a “program” or software implemented in the CPU which regulates and directs the input and output commands; said commands have been structured in accordance with each and every one of the mechanisms contained in the machine, and they have been configured according to the technical features of each mechanical element from which it will receive or to which it will send the corresponding actuating command, which obliges to maintain identical types of mechanisms to obtain an identical response of the programmed signal for each one, therefore, in the case of the replacement of one mechanism with another one of equal functionality but with different technical parameters, it would become necessary to modify the input or output commands in the central program.

It is obvious to indicate two fundamental and negative factors of the data communication systems which have been used in this type of machines up until now:

The large number of cables used for the interconnections running inside the machine.

The dependence created in each machine model, obliging being manufactured and maintained with identical electronic and electromechanical mechanisms, since if this were not done so, the software of the machine would need to be modified or it could cease to be operative in some of its functions.

### DESCRIPTION OF THE INVENTION

The machine proposed by the invention has been designed and structured in order to solve in a fully satisfactorily manner the drawbacks set forth above.

To this end and more specifically, based on the basic structure of an amusement machine of the aforementioned slot machine type, the invention allows that each and every one of the previously mentioned mechanisms or systems, such as systems for collection, payment, operational capacity and control, game development, accounting and numerical information, play information and monitoring, can be replaced with other systems or mechanisms having different features, which provides the machine with the previously mentioned multipurpose character, simply by changing in the microcontroller the necessary data corresponding to the change carried out, without the CPU central program, which is what controls the general operation of the machine as a whole, being affected.

To this end, all the secondary plates corresponding to the different systems are interconnected to the CPU main support plate through a bus and forming a loop with said main plate.

The microprocessor and the subsidiary memories where the main and general statistics, accounting, game organization and peripheral commands program has been implemented, known as the CPU, are established in the main plate, forming part of the hardware thereof. The rules regulating the execution order and actuation priority of each one of the secondary plates are fixed in the memories of said main plate.

A microcontroller and drivers, containing a partial program and the commands coming from the mechanisms which it has to interpret, as well as the commands to be sent to such mechanisms, which they have to execute by means of the drivers enabled for that purpose, are established in the secondary plates. Said plates have autonomy in their actuation, although they need execution permissions from the main plate or CPU.

At least one plate, peripheral and secondary to the main plate, for the control of the mechanisms, provided with a microcontroller and its step drivers, is serially installed with the main plate, and all of them closing a loop.

The secondary and auxiliary mechanism control plates can be two or more, a number which may vary in each case and according to the diversity of mechanism which must be controlled and the location thereof in the machine.

Therefore the replacement of one or more of the mechanisms operating in the machine with other mechanisms of a level or parameter different from the one of the replaced mechanism is possible, without this affecting the program contained in the main plate, or the rest of the secondary plates.

The replacement of any of the mechanisms entails only the modification of the data contained in the microcontroller of the plate controlling said mechanism, without said modification affecting the data contained in the CPU main plate, or the rest of the secondary plates.

A certain configuration between the microprocessor and CPU memories in the main plate and in the microcontrollers of the secondary plates, with the collaboration of a certain communication protocol, allows for the interconnection between plates by means of only two conductor cables, as has been said repeatedly.

A third cable, such as a GND for external parasite protection shielding, can be used in addition to the two prior ones.

### DESCRIPTION OF THE DRAWINGS

To complement the description being made and for the purpose of aiding to better understand the features of the invention according to a preferred practical embodiment thereof, a set of drawings is attached as an integral part of said description, in which the following has been shown with an illustrative and non-limiting character:

FIG. 1 shows a block diagram corresponding to the interconnection between the different plates of an amusement machine, carried out according to the object of the present invention.

FIG. 2 shows, according to a schematic representation, a diagram of the previous figure duly established in an amusement machine, which appears with its doors open.

### PREFERRED EMBODIMENT OF THE INVENTION

In the mentioned figures, the CPU main plate has been referenced with (1), the push button box lights plate with (2), the lights plate of the winnings plan with (3), the display plate with (4), the plate for the lights corresponding to the upper head of the machine with (5), the collection control plate with (6), the roller control plate with (7), the coin and bill selector control plate with (8), the hopper control plate with (9) and the electromechanical meter control plate with (10).

All these plates (1 to 10) are interconnected by means of a bus (11) carried out in two wires or cables with which a third cable, such as a GND, i.e. a shielding or protection element against external parasites, can optionally collaborate as previously mentioned.

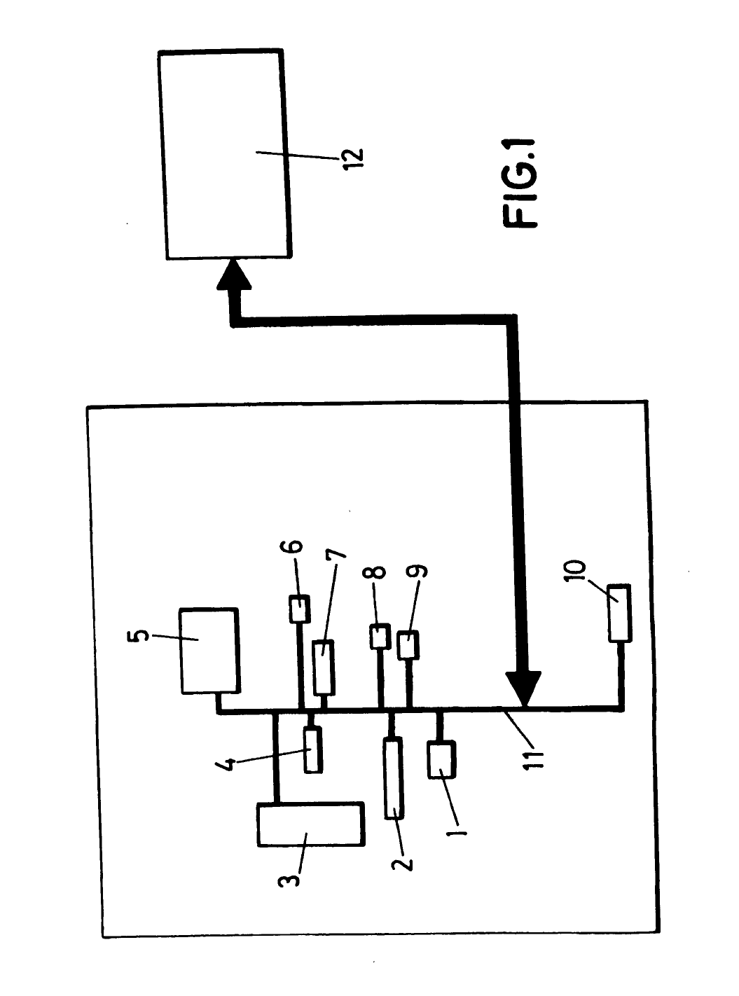

Optionally, and as shown in FIG. 1, a printer (12) can also be connected to said communication bus (11) for the evident purpose of extracting any type of printed information from the machine.

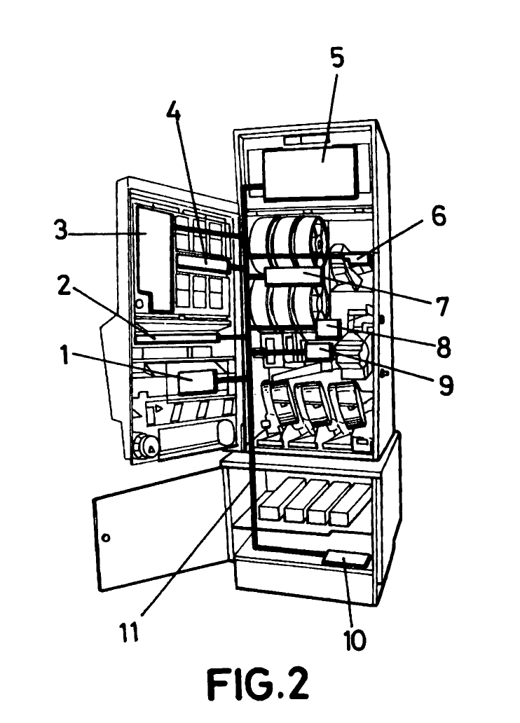

FIG. 2 shows a practical embodiment of the distribution of the relationship of the plates shown in the block diagram of FIG. 1 in the context of an amusement machine of the type mentioned.

As previously mentioned, the electronic operation of the plate is based on the main plate (1), provided with the corresponding microprocessor and the subsidiary memories where the software is implemented.

The peripheral plates (2 to 10) are each provided with a microcontroller and interconnected to one another through the previously mentioned bus (11).

Each one of said peripheral plates (2 to 10) receives information from the CPU and in the same manner sends data and responses thereto and to the rest of the peripheral plates.

Each peripheral plate (2 to 10) is structured on the basis of receiving input messages and emitting output commands to a determined group of mechanisms operating in the machine, which is carried out according to the instructions contained in the CPU program, at all times maintaining an independence in its control parameters from the mechanisms on which it directly acts.

The set of mechanisms operating in the machine are subdivided and clustered into elements of similar features, and each group of them is controlled by a peripheral plate. As each one of said peripheral plates is provided with the corresponding microcontroller, they maintain, within the dependence due to the CPU central plate, a control autonomy in relation to the actuation of the mechanisms assigned to them, such that in the event of the possible replacement of a mechanism installed in the machine with another mechanism of similar features but of a different technical response, the modification of the data for the purpose of adapting the instructions to the new mechanism only affects the peripheral plate controlling it, thereby limiting any modification to the instructions contained in said peripheral plate, the central program contained in the memories of the CPU (1) being excluded from any modification whatsoever.

1. A multipurpose amusement machine, of the type granting the user a playing time in exchange for the price of the game and possibly, according to the game program, a cash prize, which, having the purpose of allowing for the replacement of a mechanism without needing to modify the CPU base program, is characterized in that it has a hardware provided with a main plate (1) and a plurality of secondary plates (2), (3), (4), (5), (6), (7), (8), (9), (10), interconnected to one another through a bus (11), forming a loop with the main plate (1).

2. A multipurpose amusement machine according to claim 1, characterized in that a microprocessor and subsidiary memories, where the main and general statistics, accounting, game organization and peripheral commands program, known as the CPU, is implemented, are established in the main plate (1), forming part of the hardware thereof, while at the same time the rules regulating the execution order and actuation priority of each one of the secondary plates (2 to 10) are fixed in the memories of said main plate.

3. A multipurpose amusement machine according to claim 2, characterized in that a microcontroller and complementary drivers, containing a partial program and the commands coming from the mechanisms which it has to interpret, as well as the commands which such mechanisms have to execute by means of said drives, are established in the secondary plates (2 to 10), said secondary plates having autonomy in their actuation, although they need execution permission from the main plate (1) or CPU.

4. A multipurpose amusement machine according to claim 1, characterized in that the number of secondary or peripheral plates is variable, according to the diversity of mechanisms to be controlled and the location thereof in the machine.

5. A multipurpose amusement machine according to claim 1, characterized in that the mechanisms operating therein are replaceable with other mechanisms of a level or parameters different from those of the replaced mechanism, with modification of the data contained in the microcontroller of the plate controlling said mechanisms, without modification in the program contained in the main plate (1), or in the rest of the secondary plates.

6. A multipurpose amusement machine according to claim 2, characterized in that the communication bus between the microprocessor and memories of the CPU situated in the main plate (1) and the microcontrollers of the secondary plates (2 to 10) is limited exclusively to two conductor cables as a result of a certain communication protocol.

7. A multipurpose amusement machine according to claim 6, characterized in that a third cable, such as a GND for external parasite protection shielding, can optionally collaborate with the two previous cables constituting the communication bus.
